(19) United States
(12) Patent Application Publication
(10) Pub. No.: US 2017/0357041 A1
(43) Pub. Date: Dec. 14, 2017

(54) ILLUMINATION DEVICE AND DISPLAY DEVICE

(71) Applicant: Japan Display Inc., Minato-ku (JP)

(72) Inventors: Ken ONODA, Tokyo (JP); Shinichi KOMURA, Tokyo (JP); Youichi ASAKAWA, Tokyo (JP); Toshihiko FUKUMA, Tokyo (JP)

(73) Assignee: Japan Display Inc., Minato-ku (JP)

(21) Appl. No.: 15/617,568

(22) Filed: Jun. 8, 2017

(30) Foreign Application Priority Data
Jun. 10, 2016 (JP) 2016-116118

(51) Int. Cl. F21V 8/00

(52) U.S. Cl. CPC G02B 6/002; G02B 6/0038; G02B 6/003; G02B 6/0068

(57) ABSTRACT

In one embodiment, an illumination device comprises a light source, a light guide having an incidence surface, and a light refraction structure on the surface. The light guide has an irradiation direction, a thickness direction, and a width direction. The light guide has a first surface in the thickness direction and a second surface in the width direction. A first length in the width direction is greater than a second length in the thickness direction, in the structure. The light from the light source having passed through the structure is reflected on the first surface in the thickness direction and passes through the second surface in the width direction.

### CROSS-REFERENCE TO RELATED APPLICATIONS

This application is based upon and claims the benefit of priority from Japanese Patent Application No. 2016-116118, filed Jun. 10, 2016, the entire contents of which are incorporated herein by reference.

### FIELD

Embodiments described herein relate generally to an illumination device and a display device.

### BACKGROUND

A display device such as a liquid crystal display device comprises, for example, a display panel including pixels, and an illumination device such as a backlight for illuminating the display panel. The illumination device comprises a light source which emits light and a light guide which is irradiated with the light from the light source.

The light from the light source is made incident on the light guide from its end surface, propagates inside the light guide, and is emitted from an emission surface which corresponds to one of main faces of the light guide. By using a plurality of light sources emitting the light of different colors, emitted light of a desired color made by mixing these colors can also be obtained.

If a viewing angle of the light emitted from the light source is narrow, the desired brightness may not be obtainable in an area close to the light source on the emission surface of the light guide. In addition, if the structure of mixing the light of different colors is employed as explained above, the light of the colors may not be sufficiently mixed and the desired color may not be obtainable in an area close to the light source on the emission surface of the light guide.

### BRIEF DESCRIPTION OF THE DRAWINGS

FIG. 1 is a perspective view showing a schematic structure of a display device according to a first embodiment.

FIG. 2 is a perspective view showing the schematic structure of an illumination device according to the first embodiment.

FIG. 3 is a graph showing a relationship between a viewing angle and a relative intensity of light from the light source.

FIG. 4 is a schematic front view showing an illumination device according to the first embodiment.

FIG. 5 is a front view showing a hole as an example of a light refraction structure according to the first embodiment.

FIG. 6 is a cross-sectional view seen along line F6-F6 of FIG. 5.

FIG. 7 is a cross-sectional view seen along line F7-F7 of FIG. 5.

FIG. 8 is a graph showing a radiation intensity distribution of the light from the light source.

FIG. 9 is a graph showing a radiation intensity distribution of the light from the light source which has passed through the hole.

FIG. 10 is a graph showing a radiation intensity distribution in a case of using a hole having a cross-section shaped in a regular circle.

FIG. 11 is a graph showing a radiation intensity distribution according to a second embodiment.

FIG. 12 is a view showing a configuration example of an illumination device according to the second embodiment.

FIG. 13 is a view showing another configuration example of the illumination device according to the second embodiment.

FIG. 14 is a view showing yet another configuration example of the illumination device according to the second embodiment.

FIG. 15 is a schematic cross-sectional view showing a light source and a light guide according to a third embodiment.

FIG. 16 is another cross-sectional view showing the light source and the light guide according to the third embodiment.

FIG. 17 is a perspective view showing a schematic structure of an illumination device according to a fourth embodiment.

FIG. 18 is a schematic plan view showing the illumination device according to the fourth embodiment.

FIG. 19 is a schematic cross-sectional view showing the illumination device according to the fourth embodiment.

FIG. 20 is a schematic perspective view showing an illumination device according to a fifth embodiment

FIG. 21 is a view showing an action of a second lens according to the fifth embodiment.

FIG. 22 is a schematic plan view showing an illumination device according to a sixth embodiment.

FIG. 23 is a front view showing a protrusion as a light refraction structure according to a seventh embodiment.

FIG. 24 is a cross-sectional view seen along line F24-F24 of FIG. 23.

FIG. 25 is a cross-sectional view seen along line F25-F25 of FIG. 23.

FIG. 26 is a graph showing a radiation intensity distribution of the light from the light source which has passed through the protrusion.

### DETAILED DESCRIPTION

In general, according to one embodiment, an illumination device comprises a light source which emits light, a light guide having an incidence surface to which light is applied from the light source, and a recess-shaped or protrusion-shaped light refraction structure provided on the incidence surface. The light guide has an irradiation direction in which the light is applied from the light source, a thickness direction, and a width direction intersecting the irradiation direction and the thickness direction. The light guide has a first surface in the thickness direction and a second surface in the width direction. A first length in the width direction is greater than a second length in the thickness direction, in the light refraction structure. The light from the light source having passed through the light refraction structure is reflected on the first surface in the thickness direction and passes through the second surface in the width direction.

According to another embodiment, an illumination device comprises a light source which emits light, a light guide having an incidence surface to which light is applied from the light source, and a light refraction structure provided on the incidence surface. The light guide has an irradiation direction in which the light is applied from the light source, a thickness direction, and a width direction intersecting the irradiation direction and the thickness direction. The light guide has a first surface in the thickness direction and a second surface in the width direction.

Radiation intensity [W/Sr] of the light from the light source having passed through the light refraction structure is higher in vicinity of end portions in the width direction than at a central portion, and higher in vicinity of end portions in the thickness direction than in vicinity of the end portions in the width direction.

Various embodiments will be described hereinafter with reference to the accompanying drawings.

The disclosure is merely an example, and proper changes in keeping with the spirit of the invention, which are easily conceivable by a person of ordinary skill in the art, come within the scope of the invention as a matter of course. In addition, in some cases, in order to make the description clearer, the drawings are illustrated schematically, rather than as an accurate representation of what is implemented. However, such schematic illustration is merely exemplary, and in no way restricts the interpretation of the invention. In the drawings, reference numbers of continuously arranged elements equivalent or similar to each other are omitted in some cases. In addition, in the specification and drawings, the same elements as those described in connection with preceding drawings are denoted by like reference numbers, and detailed description thereof is omitted unless necessary.

Further, unless otherwise indicated in particular, such expressions used in this specification as “α includes A, B or C”, “α includes either A, B or C” and “α includes one selected from the group consisting of A, B and C” do not exclude the cases where a includes a plurality of combinations of A to C. Furthermore, these expressions do not exclude the cases where a includes some other element or elements.

A transmissive-type liquid crystal display device is described as an example of the display device in each of the embodiments. In addition, a backlight of the liquid crystal display device is described as an illumination device. However, each of the embodiments does not prevent application of individual technical ideas described in the embodiment to display devices of other types. A liquid crystal display device comprising a function of a reflective-type display device capable of reflecting external light and using the reflected light for the display besides the function of the transmissive-type display device, a display device comprising a mechanical display panel in which a micro-electromechanical system (MEMS) shutter functions as an optical element, and the like, for example, may be conceived as the display devices of the other types. A front light disposed on a front surface of the display device, and the like, for example, may be assumed as the other types of the illumination device. In addition, a device employed for a purpose different from illumination of the display device may be used as the illumination device.

### First Embodiment

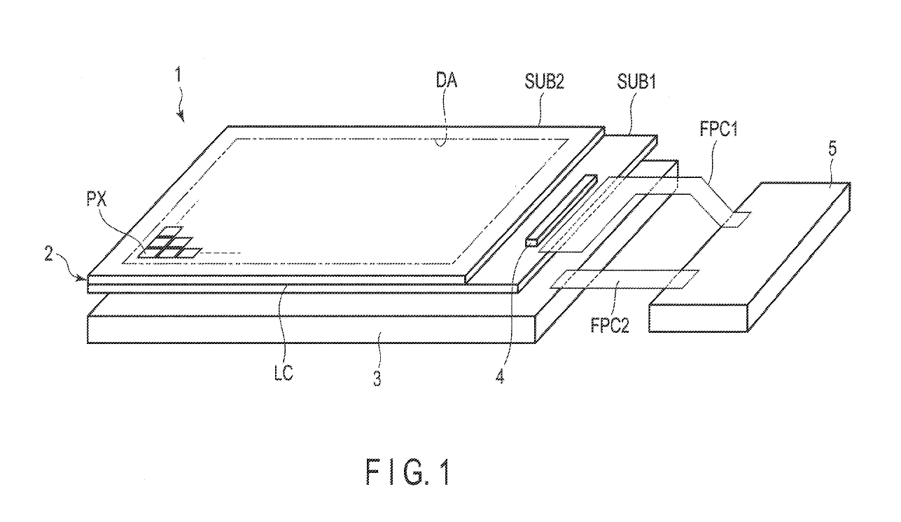

FIG. 1 is a perspective view showing a schematic structure of a display device 1 according to a first embodiment. The display device 1 can be used for, for example, various devices such as a smartphone, a tablet terminal, a mobile telephone terminal, a personal computer, a TV receiver, a vehicle-mounted device, a game console and a wearable terminal.

The display device 1 comprises a display panel 2, an illumination device 3 which serves as a backlight, a driver IC chip 4 which drives the display panel 2, a control module 5 which controls operations of the display panel 2 and the illumination device 3, and flexible printed circuits FPC1 and FPC2 which transmit control signals to the display panel 2 and the illumination device 3.

The display panel 2 comprises a first substrate SUB1, a second substrate SUB2 opposed to the first substrate SUB1, and a liquid crystal layer LC held between the first substrate SUB1 and the second substrate SUB2. The display panel 2 includes a display area DA on which an image is displayed. The display panel 2 includes, for example, pixels PX arrayed in a matrix, in the display area DA.

The illumination device 3 is opposed to the first substrate SUB1. The driver IC chip 4 is mounted on, for example, the first substrate SUB1. However, the driver IC chip 4 may be mounted on the control module 5 or the like. The flexible printed circuit FPC1 makes connection between the first substrate SUB1 and the control module 5. The flexible printed circuit FPC2 makes connection between the illumination device 3 and the control module 5.

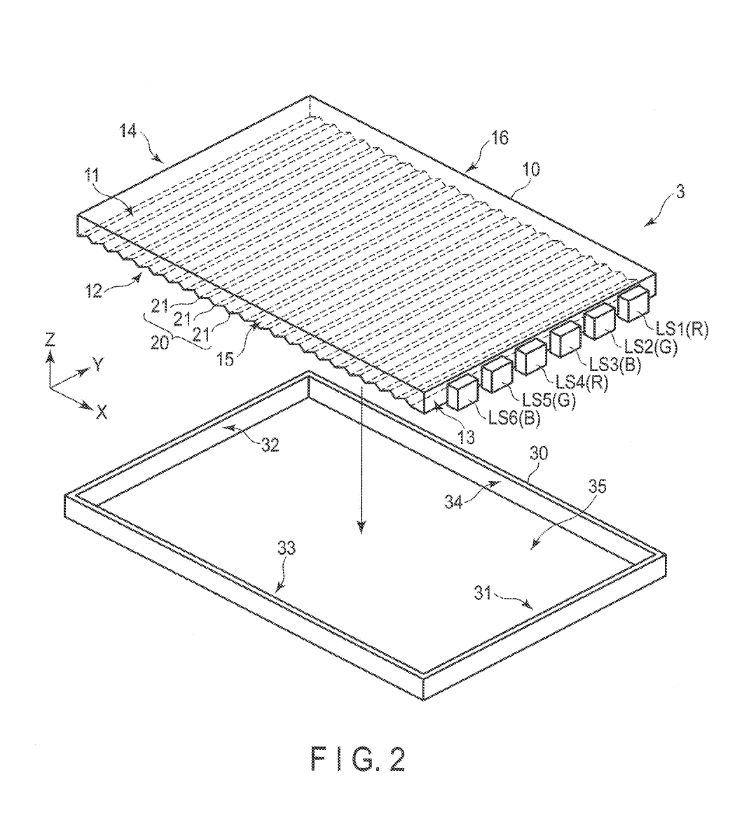

FIG. 2 is a perspective view showing the schematic structure of the illumination device 3. The illumination device 3 comprises light sources LS, a planar light guide 10, and a casing 30 which accommodates the light sources LS and the light guide 10. In the following explanations, a first direction X, a second direction Y and a third direction Z are defined as shown in FIG. 2. The first direction X is parallel to a length direction of the light guide 10. The second direction Y is parallel to a width direction of the light guide 10. The third direction Z is parallel to a thickness direction of the light guide 10. The directions X, Y, and Z are, for example, orthogonal to each other. In the present embodiment, the irradiation direction in which the light is emitted from the light sources LS is parallel to the first direction X. The irradiation direction is, for example, a direction in which the light is emitted from the light sources LS along an optical axis of the highest radiation intensity (optical axis AX2 to be explained later).

The light guide 10 includes a first main surface 11 and a second main surface 12 in the third direction Z, a first side surface 13 and a second side surface 14 in the first direction X, and a third side surface 15 and a fourth side surface 16 in the second direction Y. The first main surface 11 is an example of a first face of the light guide 10. Each of the side surfaces 15 and 16 is an example of the second face of the light guide 10. The second main surface 12 is an example of a third face of the light guide 10. Each of the main surfaces 11 and 12 is parallel to, for example, the YX plane. Each of the side surfaces 13 and 14 is parallel to, for example, the YZ plane. Each of the side faces 15 and 16 is parallel to, for example, the XZ plane.

The illumination device 3 further comprises a light emission structure 20. In the present embodiment, the light emission structure 20 is composed of a number of prisms 21 provided on the second main surface 12. The prism 21 has, for example, a triangular cross-section in the XZ plane and extends in the second direction Y. The prism 21 may have the cross-section of the other shape and may be curved in a shape having a center of curvature on the light source LS side.

In the example illustrated in FIG. 2, six light sources LS1 to LS6 are aligned along the first side surface 13. However, the number of the light sources LS is not limited to six but may be more or less than six.

The light sources LS1 and LS4 are laser light sources which emit the laser light of, for example, a red color (R). The light sources LS2 and LS5 are laser light sources which emit the laser light of, for example, a green color (G). The light sources LS3 and LS6 are laser light sources which emit the laser light of, for example, a blue color (B). For example, a semiconductor laser can be used as the laser light sources. In the present embodiment, the light from the light sources LS is assumed to be diffused light which is diffused as the travel of the light.

The light from each of the light sources LS1 to LS6 is applied to the first side surface 13 and is made incident on the light guide 10 through the first side surface 13. In other words, the first side surface 13 corresponds to an incidence surface of the light guide 10. The light propagating to the light guide 10 is subjected to total reflection by the prisms 21, thereby refracted toward the first main surface 11 and emitted from the first main surface 11. In other words, the first main surface 11 corresponds to an emission surface of the light guide 10.

The light emission structure 20 is composed of the prisms 21 provided on the second main surface 12 of the light guide 10 but is not limited to this example. The light emission structure 20 may be provided on the first main surface 11. Alternatively, the light emission structure 20 may be provided on a sheet other than the light guide 10 and this sheet may be disposed on the first main surface 11 or the second main surface 12.

The light from the light sources LS1 to LS6 is mixed inside the light guide 10. The light emitted from the first main surface 11 is therefore the mixed color of red, green and blue colors, for example, a white color. The light used for the image display can be applied to the display panel 2 by urging the first main surface 11 to be opposed to the first substrate SUB1 of the display panel 2 shown in FIG. 1.

The casing 30 includes a first side wall 31, a second side wall 32, a third side wall 33, a fourth side wall 34 and a bottom wall 35. A reflective layer which subjects the light to specular reflection is formed on an inner surface of each of the side walls 31 to 34 and the bottom wall 35. Each of the side walls 31 to 34 and the bottom wall 35 functions as a reflective member.

The light guide 10 and the light sources LS1 to LS6 are accommodated in the casing 30. In the accommodated state, the first side surface 13 is opposed to the first side wall 31, the second side surface 14 is opposed to the second side wall 32, the third side surface 15 is opposed to the third side wall 33, the fourth side surface 16 is opposed to the fourth side wall 34, and the second main surface 12 is opposed to the bottom wall 35. The light emitted from the side surfaces 13 to 16 and the second main surface 12 to the outside of the light guide 10 is reflected toward the light guide 10 by the reflective layers of the side walls 31 to 34 and the bottom wall 35. Unnecessary light leakage from the light guide 10 can be thereby prevented and the use efficiency of light at the lighting device 3 is improved.

An example in which each of the side walls 31 to 34 and the bottom wall 35 of the casing 30 functions as a reflective member is explained here. However, a reflective member other than the casing 30 may be disposed to be opposed to each of the side surfaces 13 to 16 and the second main surface 12.

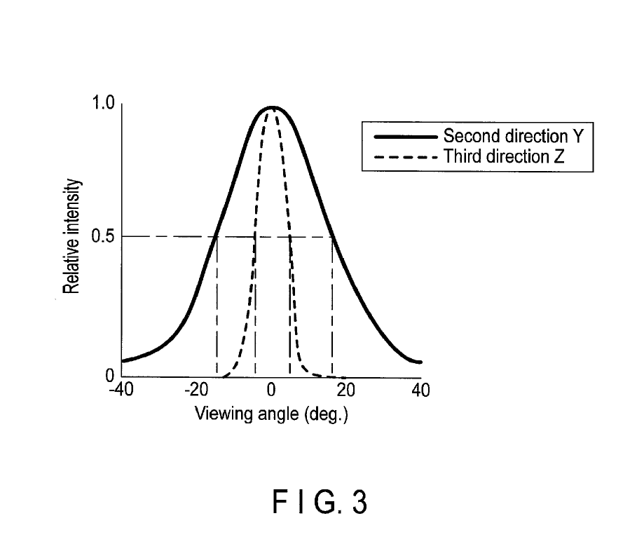

An example of the properties of the light emitted from the light source LS will be explained here. FIG. 3 is a graph showing a relationship between a viewing angle [deg.] and a relative intensity of the light from the light source LS. A curve drawn with a solid line represents a profile indicating the relationship between the relative intensity and the viewing angle in the second direction Y. A curve drawn with a broken line represents a profile indicating the relationship between the relative intensity and the viewing angle in the third direction Z. Each relative intensity is 1.0 if the viewing angle is 0 degree.

A range of the viewing angle in which the relative intensity is more than or equal to a half (0.5) of the maximum value in the second direction Y is approximately 30 degrees (−15 to 15 degrees). In contrast, a range of the viewing angle in which the relative intensity is more than or equal to a half in the third direction Z is approximately 10 degrees (−5 to 5 degrees). Thus, the range of the viewing angle of the light source LS which is the laser light source is also approximately 30 degrees, i.e., narrow in the second direction Y. Therefore, a long distance is required to mix the light emitted from the light sources LS1 to LS6.

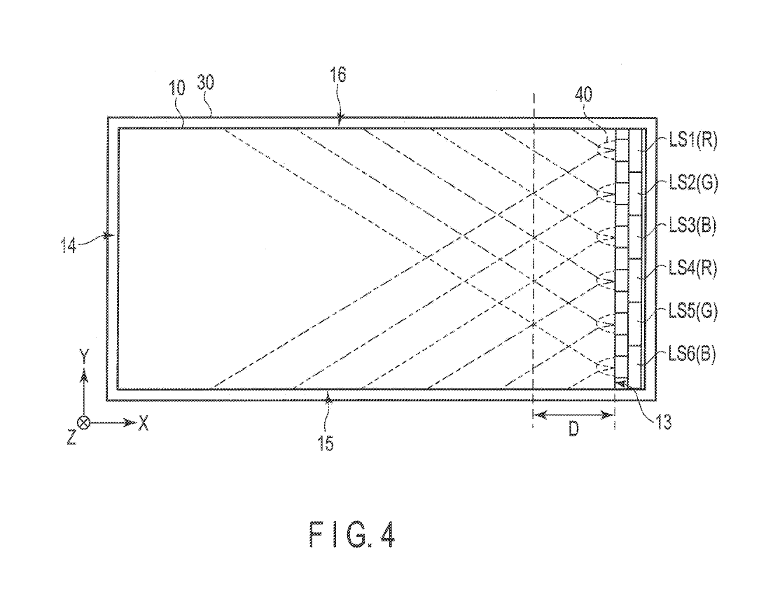

The lighting device 3 of the present embodiment has a light refraction structure for mixing the light emitted from the light sources LS1 to LS6 in a short distance. The light refraction structure will be explained hereinafter with reference to FIG. 4 to FIG. 7.

FIG. 4 is a schematic front view showing the lighting device 3. The light guide 10 includes holes 40 (recess portions) on the first side surface 13. The holes 40 are examples of the recess-shaped light refraction structures and are arranged in the second direction Y. In the example shown in FIG. 4, the holes 40 are provided for the light sources LS1 to LS6, respectively. The light sources LS1 to LS6 are disposed outside the holes 40.

The light emitted from the light sources LS1 to LS6 enters the respectively corresponding holes 40. Since the light entering the holes 40 is refracted on the surface of the holes 40, the viewing angle expands in the second direction Y. The light from the light sources LS1 to LS6 is mixed and, for example, white mixed light is generated inside the light guide 10. A distance D from the first side surface 13 to a position where the mixed light of a desired color is obtained becomes short by expanding the viewing angle of light by the holes 40.

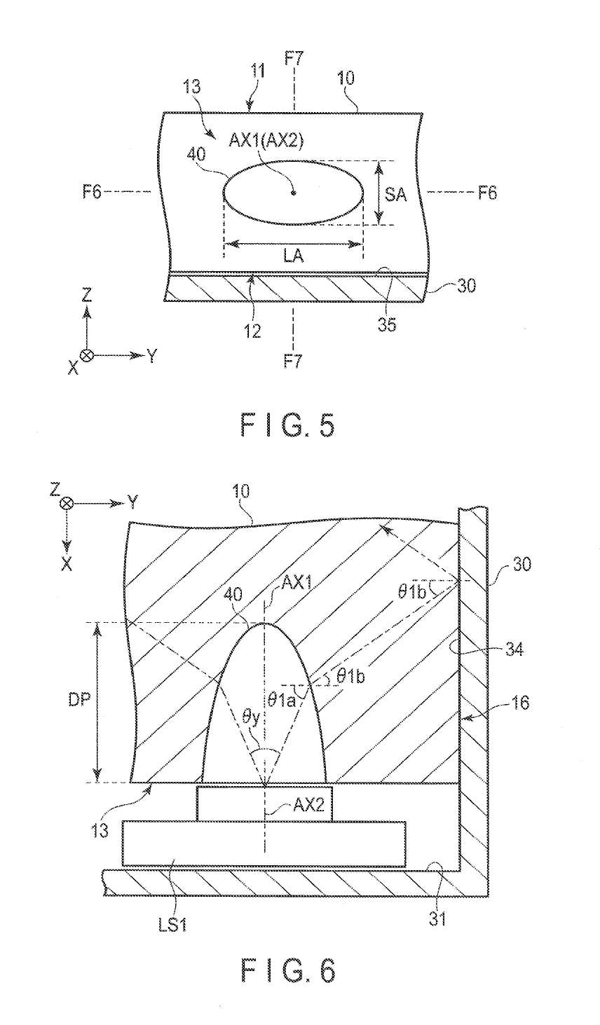

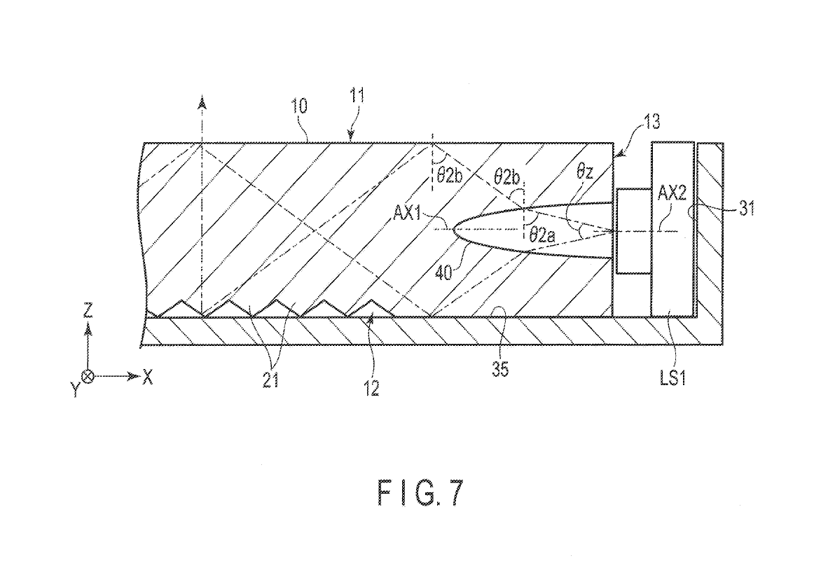

FIG. 5 is a front view showing the hole 40. FIG. 6 is a cross-sectional view seen along line F6-F6 of FIG. 5. FIG. 7 is a cross-sectional view seen along line F7-F7 of FIG. 5. The hole 40 shown in each of the figures is the hole 40 corresponding to the light source LS1. Since the structures of the other holes 40 and the relationship between the other holes 40 and the light sources LS2 to LS6 are similar, their explanations are omitted.

As shown in FIG. 5, the hole 40 is shaped in an ellipse having a major axis LA and a minor axis SA. The major axis LA corresponds to a first length of the hole 40 in the second direction Y. The minor axis SA corresponds to a second length of the hole 40 in the third direction Z. The major axis LA is longer than the minor axis SA. As shown in FIG. 6, the hole 40 has a depth DP. The depth DP is desirably longer than the length of the major axis LA from the viewpoint of expanding the viewing angle of light.

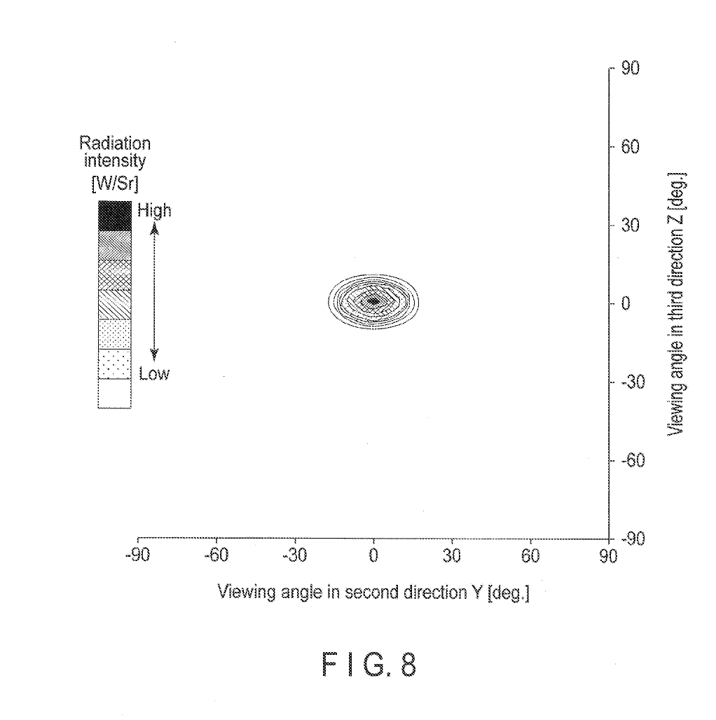

The light emitted from the light source LS1 entirely enters the hole 40. A profile of an XY plane radiation intensity of the light emitted from the light source LS1 (for example, a profile at which the radiation intensity is more than or equal to a half value) is shaped in an ellipse having a major axis parallel to the second direction Y and a minor axis parallel to the third direction Z, similarly to the hole 40 (see FIG. 8). For example, a proportion between the major axis LA and the minor axis SA is equal to a proportion between the major axis and the minor axis on an ellipsoidal profile of the light emitted from the light source LS1.

In the present embodiment, a center axis AX1 of the hole 40 is parallel to the first direction X. For example, a cross-section of the hole 40 parallel to the YZ plane is shaped in an ellipse in which the proportion between the major axis and the minor axis matches the proportion between the major axis LA and the minor axis SA at any position in the first direction X. A line segment which connects a center of the hole 40 in the cross-section at the positions in the first direction X corresponds to the center axis AX1. In addition, in the present embodiment, an optical axis AX2 of the light source LS1 matches the center axis AX1. The light emitted from the light source LS has the greatest radiation intensity in the optical axis AX2.

Optical paths of the light having half radiation intensity are represented by one-dot-chained lines in FIG. 6 and FIG. 7. These optical paths expand at a viewing angle θy in the second direction Y and expand at a viewing angle θz in the third direction Z.

As shown in FIG. 6, an angle of the light incident on the surface of the hole 40 in the XY plane is referred to as θ1a and an angle of the light emitted from this surface toward the light guide 10 is referred to as θ1b. Furthermore, as shown in FIG. 7, an angle of the light incident on the surface of the hole 40 in the XY plane is referred to as θ2a and an angle of the light emitted from this surface toward the light guide 10 is referred to as θ2b. In the present embodiment, the interior of the hole 40 is a cavity (air layer). Thus, since the refractive index of the light guide 10 is greater than the refractive index inside the hole 40, the viewing angle θ1a is wider than the viewing angle θ1b (θ1a>θ1b) and the viewing angle θ2a is wider than the viewing angle θ2b (θ2a>θ1b). In other words, the viewing angle of the light incident on the light guide 10 from the hole 40 expands in the second direction Y and the third direction Z.

As shown in FIG. 6, the light incident on the light guide 10 from the hole 40 is made incident on the fourth side surface 16 at the angle θ1b. In the present embodiment, the angle θ1b is smaller than a critical angle on the fourth side surface 16. In other words, the angle θ1b does not meet total reflection conditions on the fourth side surface 16. In this case, the light passes through the fourth side surface 16. However, the light is subjected to specular reflection on the fourth side wall 34 of the casing 30 and made incident on the light guide 10 from the fourth side surface 16 as soon as the light passes through the fourth side surface 16. The light is also emitted from the third side surface 15 without meeting the total reflection conditions but is returned to the light guide 10 by the total reflection on the third side wall 33.

In addition, as shown in FIG. 7, the light incident on the light guide 10 from the hole 40 is made incident on the first main surface 11 at the angle θ2b. In the present embodiment, the angle θ2b is greater than or equal to a critical angle on the first main surface 11. In other words, the angle θ2b meets the total reflection conditions on the first main surface 11. In this case, the light is subjected to total reflection on the first main surface 11. In the example shown in FIG. 7, a region including no prisms 21 exist on the second main surface 12. In this region, too, the light is subjected to total reflection.

If the light propagating to the light guide 10 reaches the prisms 21, at least part of the light is reflected toward the first main surface 11. This light does not meet the total reflection conditions on the first main surface 11 and is emitted from the first main surface 11. The light propagating to the light guide 10 can also be emitted from the second main surface 12 but this light is subjected to specular reflection on the bottom wall 35 and returned to the inside of the light guide 10.

The example of the optical path of the light at which the radiation intensity becomes a half value has been explained. However, the other light incident on the light guide 10 from the hole 40 does not meet the total reflection conditions on the third side surface 15 and the fourth side surface 16, either, but meet the total reflection conditions on the second main surface 12 where the first main surface 11 or the prism 21 is not formed.

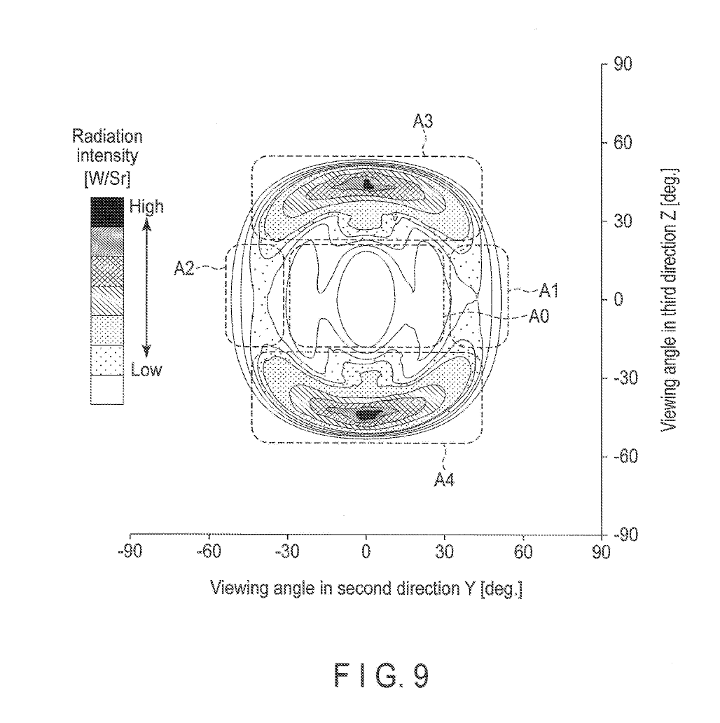

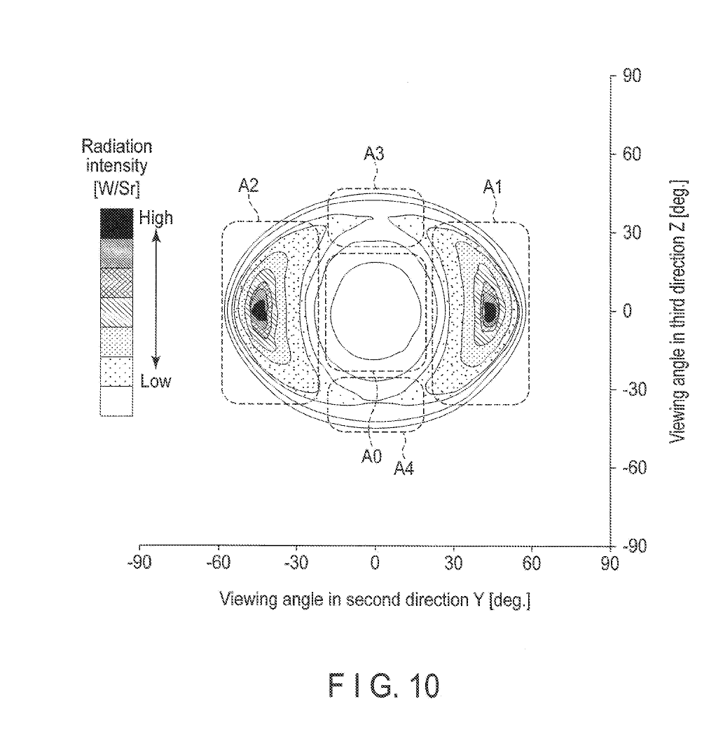

Next, the effects of the hole 40 will be explained. FIG. 8 is a graph showing a radiation intensity distribution of the light from the light source LS which is to pass through the hole 40. FIG. 9 is a graph showing a radiation intensity distribution of the light from the light source LS which has passed through the hole 40. In addition, FIG. 10 shows a comparative example. FIG. 10 is a graph showing a radiation intensity distribution in a case of using a hole in which a cross-section parallel to the YZ plane is shaped in a regular circle, instead of the hole 40. In each of the figures, the lateral axis represents the viewing angle in the second direction Y, the longitudinal axis represents the viewing angle in the third direction Z, and the radiation intensity at these viewing angles is represented by contour lines and hatching. The unit of the radiation intensity is watt per steradian [W/Sr].

As shown in FIG. 8, the radiation intensity of the light emitted from the light source LS is represented by an ellipse and distributes in an extremely narrow range. As explained above, the viewing angle in the second direction Y at which the radiation intensity is more than or equal to a half of the maximum value is approximately 30 degrees (−15 to 15 degrees), and the viewing angle in the third direction Z at which the radiation intensity is more than or equal to a half of the maximum value is approximately 10 degrees (−5 to 5 degrees).

As shown in FIG. 9, the radiation angle of the light which has passed through the hole 40 also becomes remarkably wide in the second direction Y and the third direction Z. The radiation intensity in FIG. 9 is higher in areas A1 and A2 in close vicinity to the end portions in the second direction Y than that in a central area A0. Furthermore, the radiation intensity is higher in areas A3 and A4 in close vicinity to the end portions in the third direction Z than that in the areas A1 and A2.

The light having the viewing angle close to zero degree in the third direction Z does not contact the prisms 21 shown in FIG. 2 but reaches the second side surface 14 of the light guide 10. This light is subjected to specular reflection on the second side wall 32 of the casing 30, returns to the light guide 10, contacts the prisms 21 directly or by reflection at each position, and is emitted from the first main surface 11. The light can easily be attenuated since the optical path becomes long until the light passes through the light guide 10. Thus, if the radiation intensity is high in the areas A0 to A2 in which the viewing angle is close to zero degree in the third direction Z, the use efficiency of the light from the light source LS may be lowered.

In contrast, the radiation intensity in the area A0 is sufficiently lower than that in the areas A3 and A4 in FIG. 9. The use efficiency of light can be therefore increased. Furthermore, since the radiation intensity is also lower in the areas A1 and A2 than that in the areas A3 and A4, in FIG. 9, the use efficiency of light can be further increased.

The areas A3 and A4 where the radiation intensity is higher continuously distribute in a wide range of approximately 90 degrees (−45 to 45 degrees) at the viewing angle in the second direction Y. The light from the light sources LS1 to LS6 shown in FIG. 4 is mixed in the range close to the first side surface 13 by thus expanding the viewing angle in the second direction Y. The distance D shown in FIG. 4 can be therefore shortened.

Even if the circular hole is used, the radiation intensity in the central area A0 becomes low as shown in FIG. 10. However, the radiation intensity in the areas A1 and A2 becomes higher than that in the areas A3 and A4.

In the radiation intensity distribution in FIG. 10, the radiation intensity in a range in which the viewing angle is close to zero degree in the third direction Z is higher. Since the light does not contact the prisms 21 but can reach the second side surface 14 of the light guide 10 as explained above, the use efficiency of light is lowered. In addition, the radiation intensity in a range in which the viewing angle is close to zero degree in the second direction Y is totally low in this radiation intensity distribution. If the radiation intensity distribution is thus nonuniform in the second direction Y, the mixed light of a desired color may not be able to be obtained since the light of the light sources LS1 to LS6 can hardly be mixed.

As explained above, the light can be suitably mixed even at the position close to the light sources LS1 to LS6, in the present embodiment, since the light refraction structure is provided in the light guide 10. Preferable light having non-uniformity in luminance and color suppressed can be thereby applied from the first main surface 11 which is the emission surface. In addition, the display quality of the display device 1 can be increased by thus applying the light including suppressed non-uniformity to the display panel 2. In addition, since the area for mixing the light from the light sources LS1 to LS6 needs only to be small, the display device 1 can be designed to be narrowed even if this area is provided outside the display area DA.

If the hole 40 is used as the light refraction structure, the number of components can be reduced since a light refraction structure other than the light guide 10 does not need to be prepared. Moreover, space for the light refraction structure does not need to be added.

In addition to the above, various preferable advantages can be obtained from the present embodiment.

### Second Embodiment

A second embodiment will be explained. Differences between the present embodiment and the first embodiment will be noted and explanations on the same constituent elements as those of the first embodiment will be omitted.

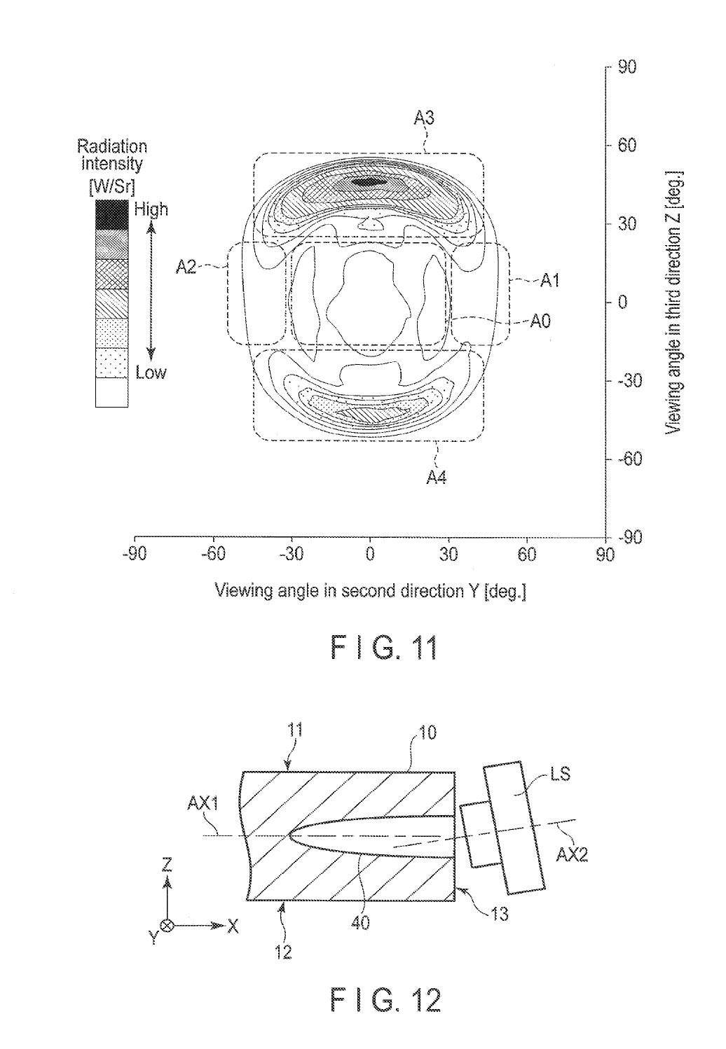

The present embodiment is different from the first embodiment with respect to a radiation intensity distribution of the light having passed through a hole 40 which is the light refraction structure. FIG. 11 is a graph showing an example of a radiation intensity distribution according to the present embodiment. In the radiation intensity distribution, of areas A3 and A4 close to both end portions in the third direction Z, radiation intensity of the area A3 is higher than that of the area A4.

An example of a structure for obtaining the radiation intensity distribution is shown in FIG. 12 to FIG. 14. Each of the figures shows a cross-section parallel to the XZ plane of a light guide 10, and a light source LS. The light source LS may be any one of the above-mentioned light sources LS1 to LS6.

In the example shown in FIG. 12, the light source LS is inclined to a second main surface 12 of the light guide 10. An optical axis AX2 of the light source LS is thereby inclined with respect to a center axis AX1 of a hole 40. More specifically, the optical axis AX2 is directed to a surface of the hole 40 on the second main surface 12 side. The center axis AX1 is parallel to the first direction X.

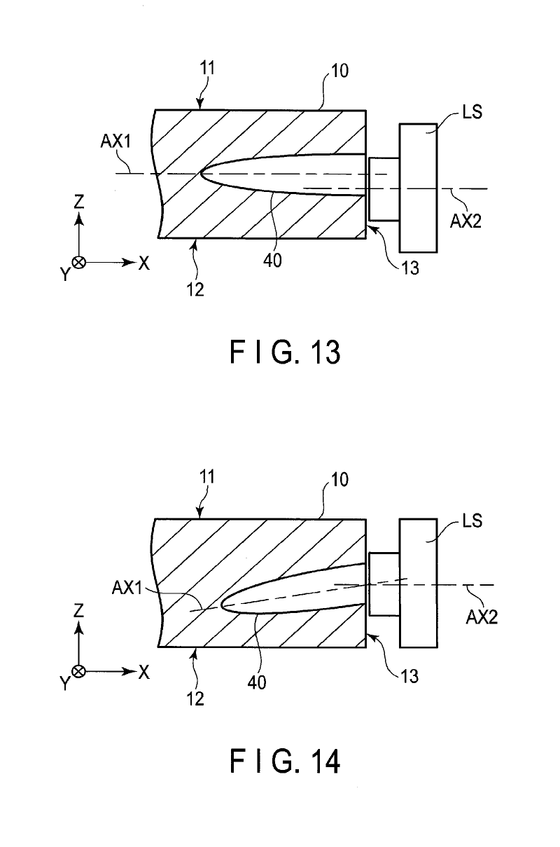

In the example shown in FIG. 13, the center axis AX1 is parallel to the optical axis AX2. However, the light source LS is displaced to the hole 40 in the direction of the second main surface 12. The center axis AX1 and the optical axis AX2 are not matched with each other and displaced in the third direction Z. Both the center axis AX1 and the optical axis AX2 are parallel to the first direction X.

In the example shown in FIG. 14, the center axis AX1 is inclined with respect to the first direction X. More specifically, the hole 40 extends toward the second main surface 12. The optical axis AX2 of the light source LS is thereby inclined with respect to the center axis AX1 of the hole 40. The optical axis AX2 is parallel to the first direction X.

As described above, the radiation intensity distribution shown in FIG. 11 can be obtained by inclining the center axis AX1 and the optical axis AX2 and displacing the axes in the third direction Z. The radiation intensity of the area A3 is higher than that of the area A4 in FIG. 11 but the radiation intensity of the area A4 may be higher than that of the area A3.

The relationship in radiation intensity between the areas A3 and A4 can be inverted by inclining the light source LS toward the first main surface 11 in FIG. 12, displacing the light source LS to the direction of the first main surface 11 in FIG. 13, or extending the hole 40 to the first main surface 11 in FIG. 14.

The same advantages as those of the first embodiment can also be obtained from the structure of the present embodiment.

Each structure disclosed in the present embodiment does not need to be applied to the light sources LS (for example, light sources LS1 to LS6) disposed in the lighting device 3 and the holes 40 corresponding to the light sources. For example, as for the light sources LS and the holes 40, a set of the light source LS and the hole 40 to which the structure of any one of the FIG. 11 to FIG. 13 is applied may exist together with another set of the light source LS and the hole 40 to which the structure of any one of the FIG. 11 to FIG. 13. Furthermore, a set of the light source LS and the hole 40 to which the structure disposed in the first embodiment may further exist together.

### Third Embodiment

A third embodiment is now explained. Differences between the present embodiment and each of the above embodiments will be noted and explanations on the same constituent elements as those of the above embodiments will be omitted.

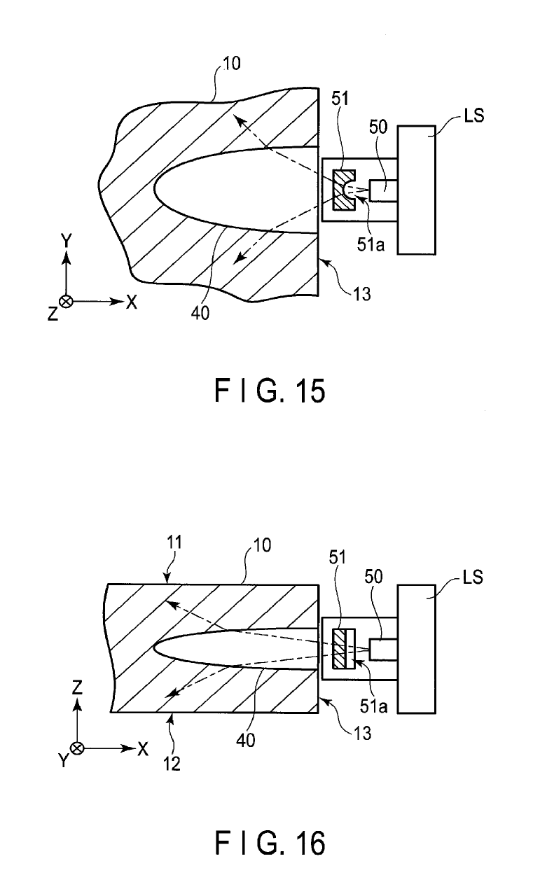

The present embodiment is different from each of the above embodiments with respect to a feature of disposing a first lens which expands a viewing angle of the light from a light source LS before the light reaches a light refraction structure. An example of disposal of the first lens will be explained with reference to FIG. 15 and FIG. 16. FIG. 15 shows a cross-section parallel to the XY plane of a light guide 10, and the light source LS. FIG. 16 shows a cross-section parallel to the XZ plane of a light guide 10, and the light source LS. The light source LS may be any one of the above-mentioned light sources LS1 to LS6.

The light source LS comprises a light emitting element 50 and a first lens 51. The first lens 51 is located between the light emitting element 50 and a hole 40. The first lens 51 includes a recess portion 51a on a surface opposed to the light emitting element 50. As shown in FIG. 16, the recess portion 51a extends in the third direction Z. As shown in FIG. 15, the cross-section parallel to the XY plane of the recess portion 51a has a semicircular shape.

As shown in FIG. 15, when the light emitted from the light emitting element 50 passes through the recess portion 51a, a viewing angle of the light in the second direction Y is expanded. When the light having passed through the recess portion 51a passes through the hole 40, the viewing angle of the light in the second direction Y is further expanded. Since the viewing angle in the second direction Y is further expanded by disposing the first lens 51, the light from the light sources LS (for example, light sources LS1 to LS6) disposed in the lighting device 3 can be suitably mixed in a range close to the first side surface.

As shown in FIG. 16, the viewing angle in the third direction Z, of the light emitted from the light emitting element 50, is hardly varied when the light passes through the first lens 51. The light from the light emitting element 50 can be therefore controlled in the third direction Z so as not to exceed a critical angle of the first main surface 11 and the second main surface 12.

The first lens 51 may be disposed in all the light sources LS (for example, light sources LS1 to LS6) disposed in the lighting device 3 or some of the light sources. In addition, the first lens 51 may be provided between the light source LS and the hole 40 outside the light source LS. The first lens 51 may include a protrusion having a circular cross-section parallel to the XY plane on the hole 40 side, instead of the recess portion 51a.

### Fourth Embodiment

A fourth embodiment will be explained. Differences between the present embodiment and each of the above embodiments will be noted and explanations on the same constituent elements as those of the above embodiments will be omitted.

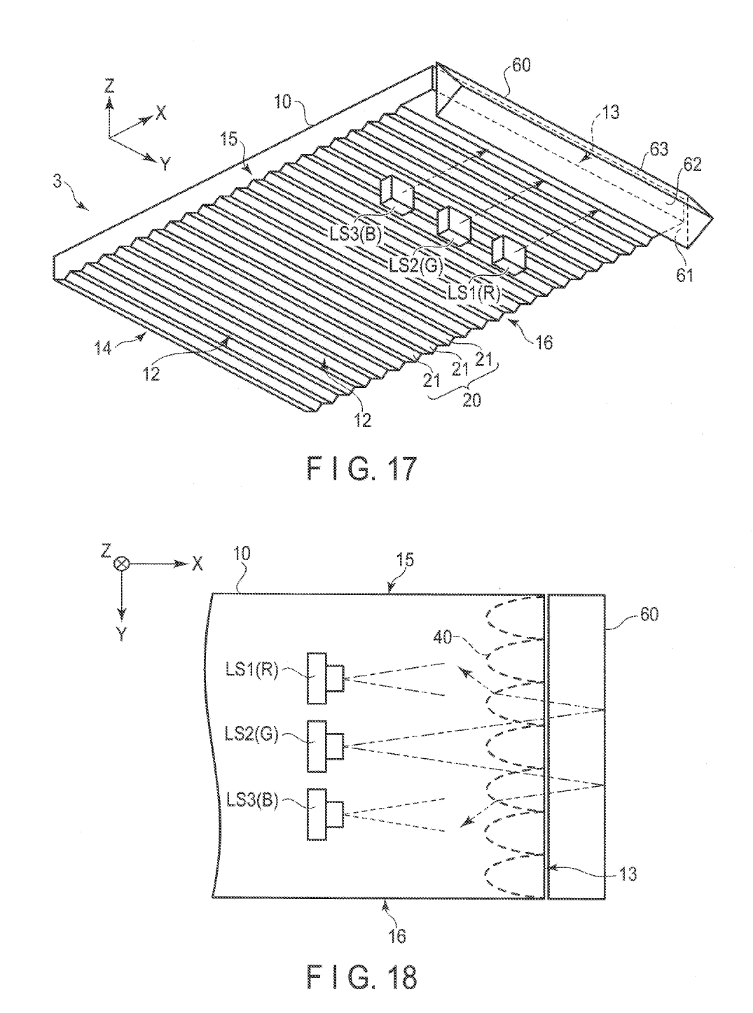

FIG. 17 is a perspective view schematically showing a structure of an illumination device 3 according to the present embodiment. The lighting device 3 comprises a casing 30 similarly to the example shown in FIG. 2 but the casing is not illustrated.

In the present embodiment, light sources LS are arranged to be opposed to a second main surface 12 of a light guide 10. In FIG. 17, three light sources LS1 to LS3 are arranged in the second direction Y. The number of the light sources LS may be larger or smaller than the example shown in FIG. 17.

The lighting device 3 further comprises a bending portion 60 which bends the light from the light sources LS1 to LS3 and applies the light to the first side surface 13 which is the incidence surface. The bending portion 60 is, for example, a triangular prism having a first prism face 61, a second prism face 62, and a third prism face 63. A part of the first prism face 61 is opposed to the first side face 13 of the light guide 10. The other parts of the first prism face 61 are opposed to the light sources LS1 to LS3. The light emitted from the light sources LS1 to LS3 is applied to the first prism face 61.

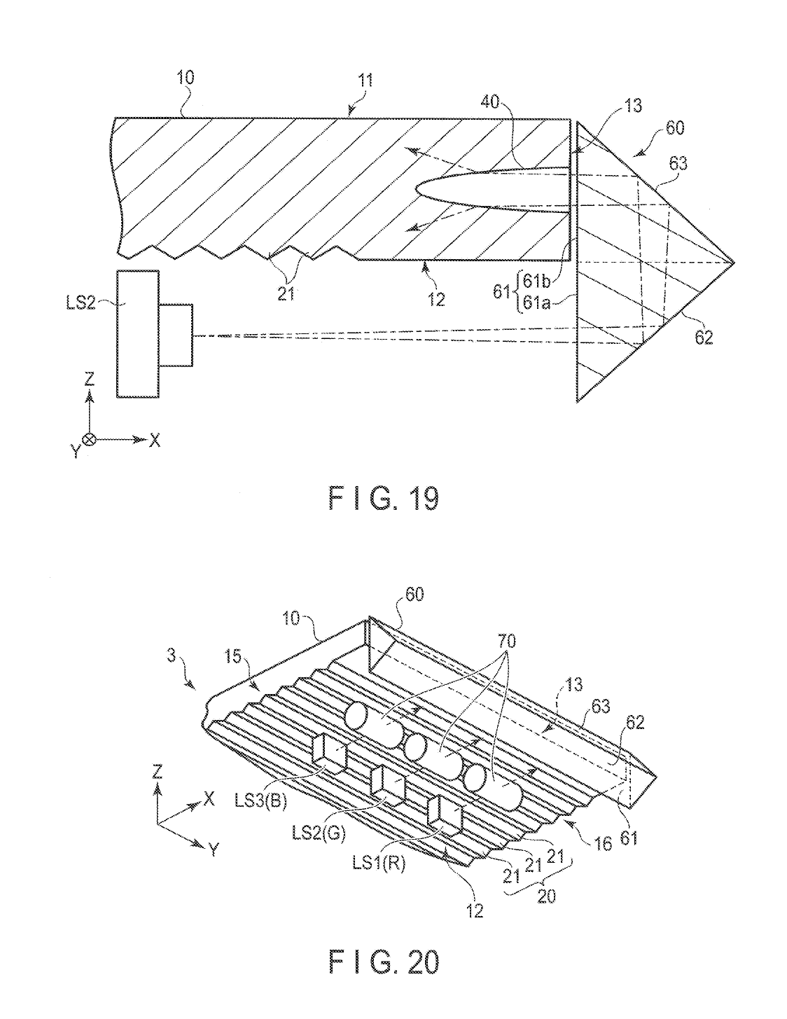

FIG. 18 is a plan view showing the lighting device 3 seen from the side of the second main surface 12 of the light guide 10. FIG. 19 is a view schematically showing a cross-section parallel to the XZ plane of the lighting device 3. The light source LS2 and an optical path of the light emitted from the light source LS2 are mainly illustrated in FIG. 19. The optical paths of the light sources LS1 and LS3 are similar to the optical path illustrated.

As shown in FIG. 18, the light guide 10 includes holes 40 as light refraction structures. In the present embodiment, the number of holes 40 is larger than the number of light sources LS. For example, the number of holes 40 may be double the number of light sources LS or more. In the example shown in FIG. 18, three light sources LS1 are provided while seven holes 40 are provided. However, the number of light sources LS and the number of holes 40 are not limited to these.

As shown in FIG. 19, the first prism face 61 includes an incidence area 61a opposed to the light source LS2 (and the light sources LS1 and LS3) and an emission area 61b opposed to the first side surface 13 of the light guide 10. The light from the light source LS2 is made incident on the bending portion 60 from the incidence area 61a. This light is subjected to total reflection on the second prism face 62, further subjected to total reflection on the third prism face 63, and emitted from the emission area 61b. The viewing angle of the light emitted from the emission area 61b is expanded by the hole 40.

The bending portion 60 thus bends the direction of travel of the light from the light sources LS1 to LS3 at 180 degrees. However, the bending portion 60 may bend the direction of travel of the light from the light sources LS1 to LS3 at an angle other than 180 degrees.

As shown in FIG. 18, the light emitted from the light sources LS1 to LS3 reaches the first side surface 13 via the bending portion 60 while expanding in the second direction Y. The optical paths from the light sources LS to the holes 40 can be kept long in a structure in which the light turns back at the bending portion 60. Therefore, the width of the light can be largely expanded in the second direction Y until the light from the light sources LS reaches the holes 40.

The light thus largely expanded is applied to the holes 40 and the viewing angle in the second direction Y is expanded. In this structure, the light from the light sources LS1 to LS3 can be mixed in a range close to the first side surface 13 as compared with the other embodiments. In addition, since the light from one light source LS is applied to the holes 40, the number of light sources LS can be reduced.

In the present embodiment, the light from one light source LS is applied in a range wider than one hole 40. Therefore, an interval between adjacent holes 40 needs to be short to urge as much light applied to the first side surface 13 as possible to enter the holes 40. For example, the interval between the adjacent holes 40 on the first side surface 13 is desirably smaller than or equal to a half of the length of the hole 40 in the second direction Y (i.e., the length of the above-mentioned major axis LA). More desirably, the adjacent holes 40 are in contact with each other without intervals on the first side surface 13.

Similarly to the third embodiment, a first lens for expanding the viewing angle in the second direction Y of the light emitted from the light source LS may be provided. Such a first lens may be, for example, built in the light source LS, similarly to the examples of FIG. 15 and FIG. 16, or disposed between the light source LS and the bending portion 60.

### Fifth Embodiment

A fifth embodiment will be explained. Differences between the present embodiment and each of the above embodiments will be noted and explanations on the same constituent elements as those of the above embodiments will be omitted.

In the structure of the above-described fourth embodiment, as shown in FIG. 19, the width in the third direction Z of the light emitted from the light source LS is also expanded in the optical path from the light source LS to the hole 40. If this width is so much expanded, the width in the third direction Z of the light reaching the first side surface 13 via the bending portion 60 may exceed the width of the first side surface 13. A second lens for controlling the width in the third direction Z of the light from the light source LS may be provided.

FIG. 20 is a schematic perspective view showing an illumination device 3 according to the present embodiment. In the example illustrated in the figure, second lenses 70 are disposed between the light sources LS1 to LS3 and the bending portion 60. The second lenses 70 may be a lens formed integrally as one body. For example, the second lens 70 is a cylindrical lens having a circular cross-section parallel to the XZ plane and extending in the second direction Y. The light from the light sources LS1 to LS3 is applied to the bending portion 60 via the respectively corresponding second lenses 70.

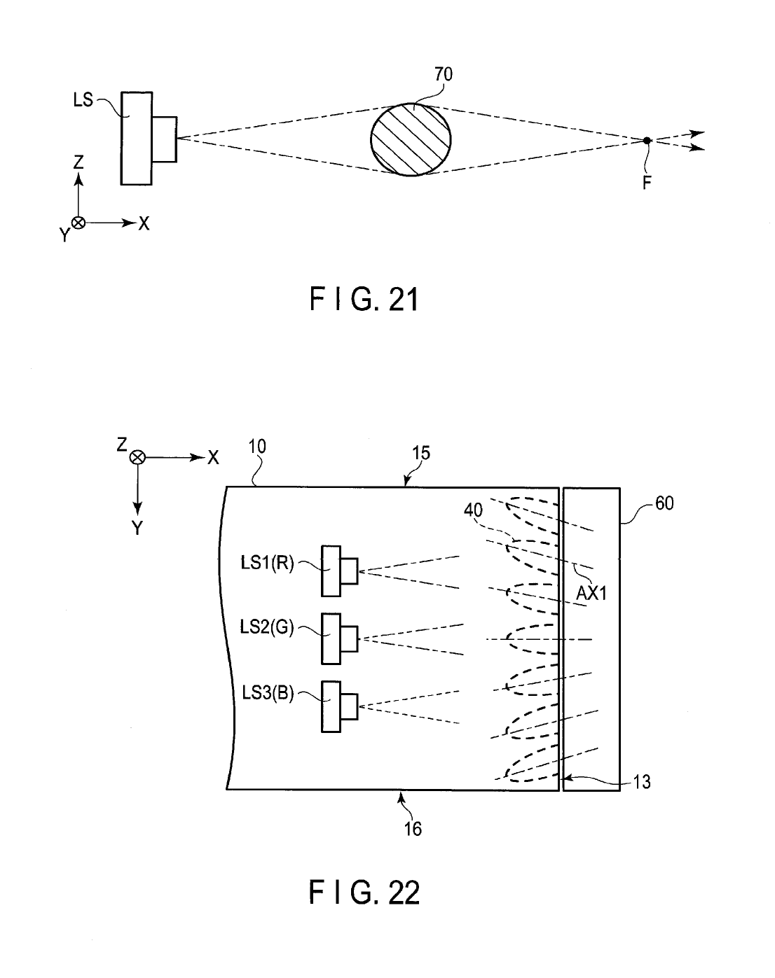

FIG. 21 is a view showing an action of the second lens 70. The light from the light source LS (LS1 to LS3) expands in the third direction Z and reaches the second lens 70. The second lens 70 bends the light and converts the light into light converged to a focus F. The width in the third direction Z of the light from the light source LS is narrowed. The bending portion 60 may be disposed at the focus F, between the focus F and the second lens 70 or a position farther from the focus F.

The second lens 70 may be disposed between the bending portion 60 and the first side surface 13 of the light guide 10. The second lens 70 may be provided in the lighting device 3 disclosed in the first to third embodiments. In this case, the second lens 70 may be disposed between the light source LS and the hole 40 corresponding to the light source LS.

### Sixth Embodiment

A sixth embodiment will be explained. Differences between the present embodiment and each of the above embodiments will be noted and explanations on the same constituent elements as those of the above embodiments will be omitted.

In the structure of the above-described fourth embodiment, since the light emitted from the light sources LS1 to LS3 is applied to the holes 40, the light entering the holes 40 is not uniform. Non-uniformity in radiation intensity of the light passing through the holes 40 may occur. Thus, in the present embodiment, a center axis AX1 of each hole 40 is appropriately inclined to suppress non-uniformity in radiation intensity of the light passing through the holes 40.

FIG. 22 is a plan view showing an illumination device 3 according to the present embodiment seen from a second main surface 12 side of a light guide 10. In the example illustrated in this drawing, a center axis AX1 of a central hole 40 in the second direction Y is parallel to the first direction X. Three holes 40 between the central hole 40 and the third side surface 15 are inclined to extend toward the third side surface 15. As these holes 40 are closer to the third side surface 15, tilt angles of the center axes AX1 in the first direction X become greater.

Three holes 40 between the central hole 40 and the fourth side surface 16 are inclined to extend toward the fourth side surface 16. As these holes 40 are closer to the fourth side surface 16, tilt angles of the center axes AX1 to the first direction X become greater.

In the present embodiment, the holes 40 are thus inclined in different directions. More specifically, if any one of the holes 40 is assumed to have a first refraction structure and any one of the other holes 40 is assumed to have a second refraction structure, a first center axis of the first refraction structure and a second center axis of the second refraction structure are not parallel to each other.

If the holes 40 are inclined as explained in the present embodiment, the light from the light sources LS1 to LS3 enters the holes 40 at angles close to the respective center axes AX1. Non-uniformity in radiation intensity of the light passing through the holes 40 can be therefore suppressed. In addition, non-uniformity in luminance and color can be consequently suppressed on the first main surface 11 which is the emission surface.

### Seventh Embodiment

A seventh embodiment will be explained. Differences between the present embodiment and each of the above embodiments will be noted and explanations on the same constituent elements as those of the above embodiments will be omitted.

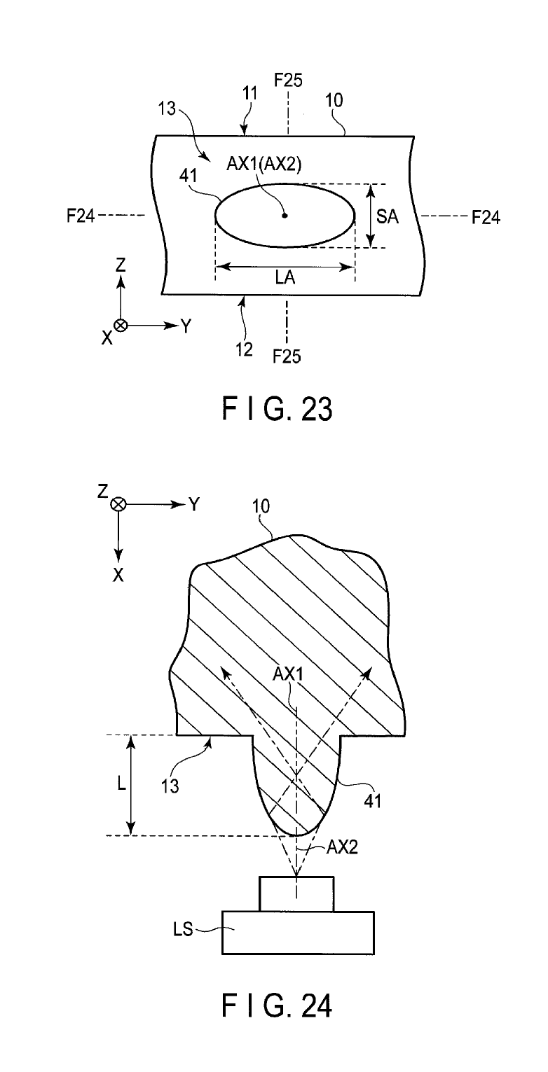

In each of the above-described embodiment, the light refraction structure is the hole 40. However, the light refraction structure may be a protruding structure which protrudes from the first side surface 13 of the light guide 10, for example, a protrusion. The light refraction structure which is the protrusion will be explained with reference to FIG. 23 to FIG. 25.

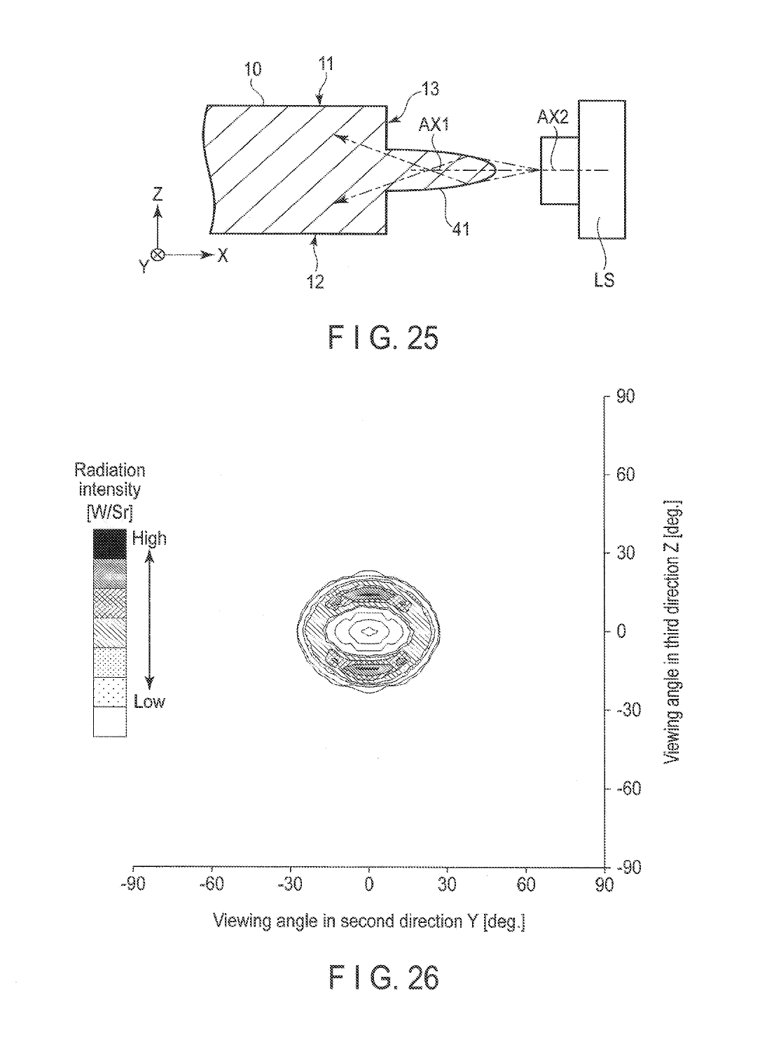

FIG. 23 is a front view showing a protrusion 41 which is the light refraction structure. FIG. 24 is a cross-sectional view seen along line F24-F24 of FIG. 23. FIG. 25 is a cross-sectional view seen along line F25-F25 of FIG. 23. The lighting device 3 comprises a casing 30 similarly to the example shown in FIG. 2 but the casing is not illustrated.

The protrusion 41 is shaped in an ellipse having a major axis LA, a minor axis SA and a center axis AX1, similarly to the hole 40. As shown in FIG. 24, the protrusion 41 has a length L. The length L is desirably greater than the length of the major axis LA from the viewpoint of expanding the viewing angle of light. For example, an optical axis AX2 of the light source LS is matched with a center axis AX1. However, the center axis AX1 and the optical axis AX2 may be inclined or displaced in the third direction Z as shown in FIG. 12 to FIG. 14.

For example, the protrusion 41 is formed integrally with the light guide 10. However, a protrusion 41 may be produced separately from the light guide 10 and connected in an appropriate method such as bonding. For example, if the light guide 10 and the protrusion 41 are integrally formed by using a mold, the mold can be produced more easily than a mold of the light guide 10 in which the hole 40 is formed.

The light emitted from the light source LS is applied to the protrusion 41. When the light passes through the surface of the protrusion 41, the light is bent and the viewing angle is expanded in the second direction Y as shown in FIG. 24. In addition, as shown in FIG. 25, the viewing angle in the third direction Z, of the light having passed through the protrusion 41, is also varied.

Similarly to the case of using the hole 40, the light having passed through the protrusion 41 does not meet the total reflection conditions on the third side surface 15 and the fourth side surfaces 16 of the light guide 10 shown in FIG. 2. In addition, the light having passed the protrusion 41 meets total reflection conditions of the first main surface 11 and the second main surface 12.

FIG. 26 is a graph showing a radiation intensity distribution of the light from the light source LS which has passed through the protrusion 41. The lateral axis represents the viewing angle in the second direction Y, the longitudinal axis represents the viewing angle in the third direction Z, and the radiation intensity at these viewing angles is represented by contour lines and hatching. The unit of the radiation intensity is watt per steradian [W/Sr].

The radiation intensity shown in FIG. 26 is higher in the vicinity of both end portions in the second direction Y than at the central portion, similarly to the case of using the hole 40 shown in FIG. 9.

Furthermore, the radiation intensity is higher in the vicinity of both end portions in the third direction Z than in the vicinity of both end portions in the second direction Y.

Thus, even if the protrusion 41 is used as the light refraction structure, the radiation intensity distribution can be obtained similarly to the case of using the hole 40. Therefore, even if the protrusion 41 is used instead of the hole 40 of each of the above-described embodiments, the advantages explained in the above-described embodiments can be obtained.

The structures disclosed in the above-described first to seventh embodiments can be combined arbitrarily.

In addition, the hole 40 having an ellipsoidal cross-section and the protrusion 41 are disclosed as the examples of the light refraction structure in each of the embodiments, but the light refraction structure is not limited to this. The shape of the light refraction structure can be appropriately modified in accordance with the required viewing angle and radiation intensity distribution.

In addition, the interior of the hole 40 in each of the embodiments may not be a cavity. In other words, the interior of the hole 40 may be filled with a filler such as resin. Such a filler is preferably formed of a material having a sufficiently lower refractive index than the light guide 10 to secure the action of expanding the viewing angle of light by the hole 40.

In each of the embodiments, the light source LS is a laser light source. However, the light source LS may be a light-emitting diode which emits light of a wider wavelength range than laser light or the like. In this case, too, the viewing angle of the light in the second direction Z can be expanded by the light refraction structure.

The light emitted from the light source LS may be excitation light such as ultraviolet light which excites a phosphor In this case, for example, a structure in which a fluorescent layer is provided on the display panel 2 and the fluorescent layer is excited by the excitation light to emit visible light can be adopted.

All of the display devices and lighting devices which can be implemented by a person of ordinary skill in the art through arbitrary design changes to the display devices and lighting devices described above as embodiments of the present invention come within the scope of the present invention as long as they are in keeping with the spirit of the present invention.

Various types of the modified examples are easily conceivable within the category of the ideas of the present invention by a person of ordinary skill in the art and the modified examples are also considered to fall within the scope of the present invention. For example, additions, deletions or changes in design of the constituent elements or additions, omissions, or changes in condition of the processes arbitrarily conducted by a person of ordinary skill in the art, in the above embodiments, fall within the scope of the present invention as long as they are in keeping with the spirit of the present invention.

In addition, the other advantages of the aspects described in the embodiments, which are obvious from the descriptions of the present specification or which can be arbitrarily conceived by a person of ordinary skill in the art, are considered to be achievable by the present invention as a matter of course.

What is claimed is:

1. An illumination device, comprising:
a light source which emits light;
a light guide having an incidence surface to which light is applied from the light source; and
a recess-shaped or protrusion-shaped light refraction structure provided on the incidence surface,
wherein
the light guide has an irradiation direction in which the light is applied from the light source, a thickness direction, and a width direction intersecting the irradiation direction and the thickness direction,
the light guide has a first surface in the thickness direction and a second surface in the width direction,
a first length in the width direction is greater than a second length in the thickness direction, in the light refraction structure, and
the light from the light source having passed through the light refraction structure is reflected on the first surface in the thickness direction and passes through the second surface in the width direction.

2. The illumination device of claim 1, wherein
radiation intensity [W/Sr] of the light from the light source having passed through the light refraction structure is higher in vicinity of end portions in the width direction than at a central portion, and higher in vicinity of end portions in the thickness direction than in vicinity of the end portions in the width direction.

3. The illumination device of claim 1, further comprising:
a reflective member which reflects the light emitted from the second surface toward the second surface.

4. The illumination device of claim 1, wherein
the light refraction structure is a hole provided on the incidence surface.

5. The illumination device of claim 1, wherein
the illumination device comprises a plurality of light refraction structures arranged in the width direction.

6. The illumination device of claim 5, wherein
the illumination device comprises a plurality of light sources, and
number of the light sources is more than number of the light refraction structures.

7. The illumination device of claim 5, wherein
the plurality of light refraction structures includes a first light refraction structure and a second light refraction structure,
the first light refraction structure has a first center axis,
the second light refraction structure has a second center axis, and
the first center axis and the second center axis are not parallel to each other.

8. The illumination device of claim 1, further comprising:
a lens between the light refraction structure and the light source,
wherein the lens controls a width in the thickness direction, of the light from the light source.

9. The illumination device of claim 1, further comprising:
a bending portion opposed to the incidence surface,
wherein
the light guide has a third surface on a side opposite to the first surface, in the thickness direction,
the light source is opposed to the third surface and emits the light to the bending portion, and
the bending portion bends the light from the light source and applies the light to the incidence surface.

10. A display device, comprising:
a display panel which urges the light to be selectively transmitted to display an image; and
the illumination device of claim 1 which applies the light to the display panel.

11. An illumination device, comprising:
a light source which emits light;
a light guide having an incidence surface to which light is applied from the light source; and
a light refraction structure provided on the incidence surface,
wherein
the light guide has an irradiation direction in which the light is applied from the light source, a thickness direction, and a width direction intersecting the irradiation direction and the thickness direction,
the light guide has a first surface in the thickness direction and a second surface in the width direction, and
radiation intensity [W/Sr] of the light from the light source having passed through the light refraction structure is higher in vicinity of end portions in the width direction than at a central portion, and higher in vicinity of end portions in the thickness direction than in vicinity of the end portions in the width direction.

12. The illumination device of claim 11, wherein
the radiation intensity [W/Sr] of the light from the light source having passed through the light refraction structure is higher in vicinity of one of the end portions than in vicinity of the other end portion in the thickness direction.

13. The illumination device of claim 11, further comprising:
a reflective member which reflects the light emitted from the second surface toward the second surface.

14. The illumination device of claim 11, wherein
the light refraction structure is a hole provided on the incidence surface.

15. The illumination device of claim 11, wherein
the illumination device comprises a plurality of light refraction structures arranged in the width direction.

16. The illumination device of claim 15, wherein
the illumination device comprises a plurality of light sources, and
number of the light sources is more than number of the light refraction structures.

17. The illumination device of claim 15, wherein
the plurality of light refraction structures includes a first light refraction structure and a second light refraction structure,
the first light refraction structure has a first center axis,
the second light refraction structure has a second center axis, and
the first center axis and the second center axis are not parallel to each other.

18. The illumination device of claim 11, further comprising:
a lens between the light refraction structure and the light source,
wherein the lens controls a width in the thickness direction, of the light from the light source.

19. The illumination device of claim 11, further comprising:
a bending portion opposed to the incidence surface,
wherein
the light guide has a third surface on a side opposite to the first surface, in the thickness direction,
the light source is opposed to the third surface and emits the light to the bending portion, and
the bending portion bends the light from the light source and applies the light to the incidence surface.

20. A display device, comprising:
a display panel which urges the light to be selectively transmitted to display an image; and
the illumination device of claim 11 which applies the light to the display panel.
